(19) United States
(12) Patent Application Publication
(10) Pub. No.: US 2012/0071581 A1
(43) Pub. Date: Mar. 22, 2012

(54) Bag-on-valve aerosol dispensing arrangement and chemical formulations

(76) Inventor: Ross J. Sklar, Santa Monica, CA (US)

(21) Appl. No.: 13/199,445

(22) Filed: Aug. 29, 2011

Related U.S. Application Data
(60) Provisional application No. 61/402,359, filed on Aug. 30, 2010.

(51) Int. Cl. C09D 5/14; C09J 131/04; C08K 5/06

(52) U.S. Cl. 523/122; 524/377

(57) ABSTRACT

Additive combinations for various products to allow the product to be dispenses from a BOV aerosol dispensing arrangement.

### BACKGROUND OF THE INVENTION

1. Field of the Invention

This invention relates to the Bag-on-Valve (BOV) aerosol can dispensing art and more particularly to new internal mixing media and the chemical formulations of various liquid products for the purposes of successfully using BOV technology.

2. Description of the Prior Art

BOV aerosols have heretofore been used for many different applications in the cosmetic and personal care product channel that don't have the challenges some industrial chemicals have in this format. A BOV aerosol can dispenser generally consists of a flexible bag, sometimes called a container, and as utilized herein, bag refers to any type of container for containing the material that is to be dispensed and the bag is internally attached to the actuator valve in the interior of the aerosol can. The can is then pressurized generally by compressed air in the volume between the bag and the interior surface of the can thus surrounding the bag with the pressurized air. When it is desired to dispense the liquid the actuator is depressed opening a channel through a valve into the interior of the bag and the compressed air squeezes the bag dispensing the contents through the valve and actuator to regions external of the aerosol can. When dispensing is terminated, the actuator is released, the valve closes and the contents of the bag is then again sealed. Such operation is continued until the pressurized air has completely collapsed the bag thus dispensing all of the liquid in the bag.

However, traditionally, BOV aerosol dispensing arrangements have not been utilized to spray specific industrial, commercial or Do It Yourself (DIY) paints/coatings, adhesives, separating cleaning, disinfecting, pesticide or insecticide liquid chemical products. The aforementioned products in their standard bulk formulation cannot be dispensed from a BOV aerosol dispenser arrangement because of the product's physical characteristics and the incompatibility with the BOV aerosol components. The above mentioned products are either too thick, that is too viscous, to be sprayed efficiently, the liquids become unstable and separate in the BOV, the liquids dry to quickly and cannot be sprayed, the liquids clog the valve or actuator or are too aggressive and harm the bag or other components of the BOV dispensing arrangement

Thus, it has long been desired to provide a aerosol dispensing arrangement for liquids that have not heretofore been able to be dispensed from a BOV aerosol dispensing arrangement. It is desired that when utilizing the BOV in the aerosol dispensing arrangement that the bag material to be used is a layered configuration consisting of an initial layer of either polyethylene and/or polypropylene followed by a nylon, aluminum or PET layer as this is a chemical resistant and a stable material configuration that will not degrade in the presence of harsh chemicals. It is also desired that when utilizing the BOV in the aerosol dispensing arrangement that the valve to be used is made of polyethylene and/or polypropylene material as this is a chemical resistant and stable material that will not degrade in the presence of harsh chemicals. It is further desired that when utilizing the BOV aerosol dispensing arrangement for certain of the more viscous liquids to be dispensed that the valve must not be any smaller than 1 inch in size so that more viscous materials can pass through and be evacuated from the valve.

It is still further desired that when utilizing the BOV in the aerosol dispensing arrangement that a lathe cut gasket or washer like material is affixed to the underside of the mounting-cup to aid in sealing the BOV to the container. It is also desired that when utilizing the BOV aerosol dispensing arrangement a marble or other object be placed into the bag during the manufacturing process of the BOV depending on the formula. The marble or other object in the bag will mix the product in the bag when the product is shaken and keep certain liquids homogenous for successful spraying of the BOV.

Accordingly, it is an object of the present invention to provide an improved BOV aerosol dispensing arrangement.

It is another object of the present invention to provide and improved BOV aerosol dispensing arrangement for liquid chemicals and/or liquid chemical combinations of industrial, commercial or DIY paints/coatings, adhesives, cleaning, disinfecting, pesticide or insecticide products.

It is still a further object of the present invention to provide one or more additives in a BOV aerosol dispensing arrangement for dispensing liquid chemicals in which such chemicals or combinations and/or mixtures of such various chemicals are, without such additives, too viscous and/or dry quickly, separate in the bag, tend to clog the valves of the aerosol dispensing arrangement, and/or are so aggressive that the bag or other components of the BOV aerosol dispensing arrangement are damages by the liquid chemical to be dispensed.

### SUMMARY OF THE INVENTION

The above and other objects of the present invention are achieved, according to the principals of the present invention by providing one or more additives to the liquid chemicals or chemical combinations to be dispensed and which additives alleviate the characteristics of the liquid chemicals or chemical combinations to be dispensed which will allow such liquid chemicals or chemical combinations to be dispensed in a BOV aerosol dispensing arrangement.

The additives to be utilized are selected for the particular liquid chemicals or chemical combinations to be dispensed from a group of additives having known characteristics which interact with the liquid chemicals or chemical combinations to be dispensed. The mixture of the additives with the liquid chemicals or chemical combinations permits the dispensing so that such liquid chemicals or chemical combinations may be repeatedly dispensed from BOV aerosol dispensing arrangement multiple times until all the liquid chemicals or chemical combinations to be dispensed have been dispensed.

### BRIEF DESCRIPTION OF THE DRAWING

FIG. 1 is a representation of typical BOV aerosol dispensing arrangement useful in the practice of the present invention.

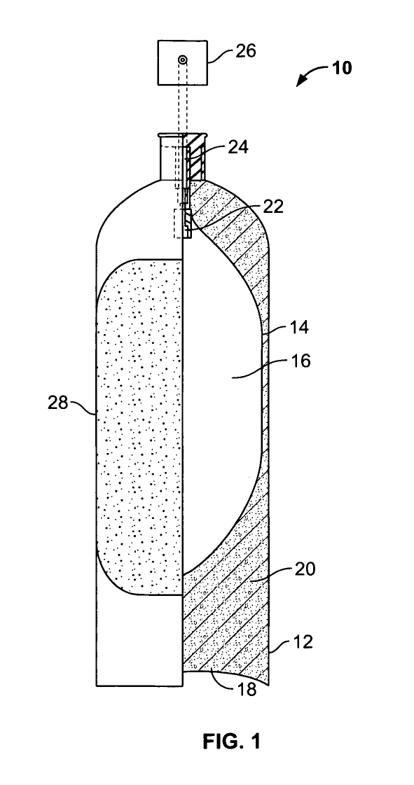

### DESCRIPTION OF THE PREFERRED EMBODIMENTS

Referring now to the drawing there is shown a typical BOV aerosol dispensing arrangement 10. The dispensing arrangement 10 has a rigid can 12, which is often fabricated from aluminum and a flexible bag 14 containing the product 16 that is to be dispensed. A volume 18 is provided between the bag 14 and the can 12. A compressed gas 20 such as air, nitrogen, or other compatible gas, fills the volume 18. The bag 14 is selected from materials that are compatible with the product 16 to be dispensed. A valve 22 is provided to allow communication with the interior of the bag 14.

In the production of the complete BOV aerosol dispensing arrangement 10, a process generally described as an under the cup gassing system is often utilized. In such an under the cup gassing system, in general the bag 14 is placed in the can 12 and the valve 22 is attached to the bag. The cup of the valve 22 is lifted away from the can 12 and the compressed gas 20 is injected into the volume 20 until the desired pressure above atmospheric pressure is reached. Once the desired pressure of the gas 20 is reached, the valve 22 is pushed back down into the can 12 and crimped in place on the neck of the can 12. The product 16 is then injected into the bag 14 through the valve 22 generally by utilizing a pressure filling system. When the desired amount of product 16 is in the bag 14, the actuator 24 is placed on the valve 22 and a cover cap 26 is placed over the exposed end of the actuator 24. Finally, a label 28 may be placed on the can 12.

In dispensing the product 16, the actuator 24 is depressed into the valve 22 providing a channel through the valve 22 and actuator 24 for the product 16 to be releases to the atmosphere. The output pressure follows Boyles Law: as the product 16 is released, the internal pressure in the can 12 decreases.

It has been found that the bag 14 in a BOV aerosol dispensing arrangement for dispensing of the materials described herein, may advantageously be comprised of a layered construction. There may be provided an initial layer of either polyethylene or polypropylene followed by a nylon, polyethylene terephthalate (PET) and an outermost layer of aluminum. Additionally, the valve is preferably fabricated from polyethylene or polypropylene as these materials are chemically resistant and very stable and do not degrade in the presence of harsh chemicals. Also, in a BOV aerosol dispensing arrangement for dispensing of the materials described herein, it is desired that a lathe cut gasket or washer like material be affixed to the underside of the valve mounting cup to aid in sealing the bag 14 in the can 12. If desired, one or more marbles may be placed in the bag 14 so that when it is desired to dispense the product 16, the can 12 may be shaken and the marbles tend to mix the product 16 in the bag 14 to aid in maintaining a homogeneous mixture of the product 16.

The following is a listing of the additives that have been found useful in adding to various liquid chemicals or chemical combinations to be dispensed from a BOV aerosol dispensing arrangement.

Additives to be added are utilized to manipulate existing paint and coatings, adhesives, caulking, cleaning chemicals, disinfecting, pesticide and/or insecticide products or formulae to ensure their stability, effectiveness, sprayability and successful storage and use in a BOV format are set forth below as Listing A:

### Listing A

### Additives

1) Inorganic fillers: Can help rheology and create a more flowable product making spraying easier.
2) SNC—Silica Nancomposites: Can improve natural surfactant properties and effect flowability making it easier to spray.
3) Soy-gel: Can help with in-can stability so liquids do not separate in the BOV
4) Absorbents: Can help create homogenous materials where separation can occur.
5) Coupling Agents: Can also help create homogenous formulas to prevent separating and clogging.
6) Anti-foaming/Defoamer agents: Prevents the formation of foaming which is a problem in water-based products.
7) Anti-gelling Agents: Prevents the liquid from gelling.
8) Anti-livering: Prevents the product from congealing.
9) Anti-settling Agent: Will prevent products from settling out and maintain uniformity.
10) Chelating Agents: Will react with free metals in the product and render them harmless which can improve a coatings flowability.
11) Coalescents: Will add to a coatings flowability and ease of spray by plasticization.
12) Corrosion Inhibitors: Can prevent potential corrosion in the BOV.
13) Deflocculant: Will prevent materials from forming floccs.
14) Detergent: Is a surfactant that is used to have self cleaning properties to prevent clogging in the BOV.
15) Diluent: Could be used to make product spray and can prevent clogging of the BOV.
16) Dispersant: Can increase stability of the liquid in the BOV.
17) Emulsifier: Used to produce a stable mixture to prevent separation.
18) Essential Oils: Can produce more lubricity to help in spraying and prevent clogging.
19) Flow & Leveling Agents and Flow Modifiers: These increase the products mobility and can aid in preventing clogging issues.
20) Freeze-Thaw Stabilizers: These can prevent water-based liquids from freezing which can inhibit spray performance.
21) Homogenizer: An agent that aids in keeping a liquid homogeneous.
22) Humectants: These compounds will prevent liquid products from drying out which can help flowability.
23) Lubricants: These additive can help a liquids stability, sprayability and clogging.
24) pH-Control Agents: These agents help control the pH which is essential and help maintain a liquids stability.
25) Plasticizers: This material helps the flexibility of a liquid and can prevent clogging.
26) Retention Aids: These compounds slow down the evaporation rate.
27) Rheology Modifier: This can modify the liquid to make the product spray better and more flowable which can help prevent clogging.
28) Spreading Agent: These can reduce surface tension and enhance flow which can prevent clogging.
29) Surfactants: These can alter the surface properties and enhance spreading which can make it easier to spray and can help prevent clogging.
30) Suspension Agents: These will improve a products resistance to pigment settling and separation which can make the product remain stable in a BOV.
31) Waxes: Also encompass other products like PP or PTFE and these can help a liquids flowability and can prevent products from clogging.

The following are various examples of the formulae of typical products that have heretofore been incapable of being successfully or satisfactorily dispensed from a BOV aerosol dispensing arrangement and the additives selected from Listing A that enables the mixture of the product and the additive(s) to be dispensed from a BOV aerosol dispensing arrangement. The formulae for the products listed below are typical of the those utilized in the industry. However, those skilled in the art know the various precise formulations of such and other products and the characteristics thereof so that a selection of the proper additive(s) having the characteristics in Listing A may be made for the particular product to allow the dispensing of the mixture of the product and the additive(s) from a BOV aerosol dispensing arrangement. The three examples set forth below are only representative of the combinations of products and additives that may be made in accordance with the teachings of the present invention. Depending on the characteristics of the product one or more of the additives form the Listing A may be added to the product.

### Example 1

### Colored Concrete Coating

A typical formulation for a coating for concrete, cement or the like, of the type which heretofore has not been successfully dispensed from a BOV aerosol dispensing arrangement is shown in Table 1. Such colored concrete coating with the ingredients listed in Table 1 generally has a characteristic that it will tend to separate and not retain a homogeneous mixture.

TABLE 1
COLORED CONCRETE COATING

| | % by | | |
|---|---|---|---|
| Product | Volume | Description | Manufacturer |
| Water | 60-80 | Water | N/A |
| BYK-028 | 0.05-1 | Defoamer | BYK Additives |
| Raykote 1435 | 15-30 | Acrylic resin | Specialty |
| | | | Polymners Inc. |
| Mergal 186 | .05-1 | Antimicrobial | Troy |
| | | | Antimicrobial |
| Michelman 71235 | 1-5 | Wax additive | Michelman Inc. |
| Red oxide | 1-5 | Pigment | Dayglo |

In order to change the characteristics of the colored concrete coating of Table 1 so that the coating may be dispensed from a BOV aerosol dispensing arrangement and still retain the desired coating characteristics and stay homogeneous in the bag, certain of the additives listed above in Listing A are mixed with the colored concrete coating of Table 1 to prevent, for example, the separation thereof while in the BOV aerosol dispensing arrangement.

Table 2 shows the colored concrete coating of Table 1 with the desired selected additive or additives from the aforesaid Listing A to provide a colored concrete coating and additive(s) mixture which may be dispensed from a BOV aerosol dispensing arrangement.

TABLE 2
BOV DISPENSABLE COLORED
CONCRETE COATING MIXTURE

| | % by | | |
|---|---|---|---|
| Product Name | Volume | Description | Manufacturer |
| Water | 60-80 | Water | N/A |
| BYK-028 | 0.05-1 | Defoamer | BYK Additives |
| Raykote 1435 | 15-30 | Acrylic resin | Specialty |
| | | | Polymer Inc. |
| Mergal 186 | .05-1 | Antimicrobial | Troy |
| | | | Antimicrobials |
| Michelman 71235 | 1-5 | Wax additive | Michelman Inc. |
| Red oxide | 1-5 | Pigment | Dayglo |
| ADDITIVES FROM | | | |
| LISTING A: | | | |
| 1. Calcium Carbonate | 5-15 | Inorganic | Omya |
| | | Filler | |
| 2. Fumed Silica | 1-3 | Silica | Degussa |
| | | Nancomposites | |
| 4. Attagel Clay | 1-3 | Absorbents | BASF |
| 5. Tin Catalyst | 0.5-1 | Coupling | Kenrich |
| | | Agents | |
| 9. Cellulose Thickener | 2-5 | Anti-settling | Akzo Nobel |
| | | agent | |
| 17. Ninate 411 | 2-5 | Emulsifier | Stepan Company |
| 21. Norfox NP9 | 2-5 | Homogenizer | Norman Fox |
| 30. Acrysol DR73 | 2-5 | Suspension | Roman Hass |
| | | Agent | |

By adding any of the listed additives in Table 2 to the colored concrete coating of Table 1, the colored concrete coating will not separate in the bag and will stay homogeneous.

### Example 2

### Paint Coating

A typical formulation for a paint coating of the type which has generally heretofore not been successfully capable of being dispensed from a BOV aerosol dispensing arrangement is shown in Table 3. Such a paint coating having the ingredients as set forth in Table 3 generally has a characteristic, for example, that the viscosity thereof is too great to allow it to be sprayed from a BOV aerosol dispensing arrangement.

In order to change the characteristics of the paint coating of Table 3 so that the product may be dispensed from a BOV aerosol dispensing arrangement one or more of the additives form Listing A are mixed with the paint coating of Table 3 to provide a paint coating mixture that may be dispensed from a BOV aerosol dispensing arrangement.

TABLE 3
PAINT COATING

| | % by | | |
|---|---|---|---|
| Product | Volume | Description | Manufacturer |
| Neocryl A-6044 | 70-90 | Acrylic Resin | DSM |
| BYK-028 | 0.05-1 | Defoamer | BYK Additives |
| Lamp Black | 1-5 | Liquid Pigment | Dayglo |
| Liquid Pigment | | | |

Table 4 shows the paint coating of Table 3 with the additives selected from Listing A to provide the paint coating mixture so that the viscosity will be reduced to a value to allow successful dispensing from a BOV aerosol dispensing arrangement.

TABLE 4
BOV DISPENSABLE PAINT COATING MIXTURE

| | % by | | |
|---|---|---|---|
| Product | Volume | Description | Manufacturer |
| Neocryl A-6044 | 70-90 | Acrylic Resin | DSM |
| BYK-028 | 0.05-1 | Defoamer | BYK Additives |
| Lamp Black Liquid | 1-5 | Liquid Pigment | Dayglo |
| Pigment | | | |
| 7. Propylene Glycol | 5-15 | Anti-gelling | Univar |
| | | agent | |
| 8. DPM: Dipropylene | 5-15 | Anti-livering | Univar |
| glycol methyl ether | | agent | |
| ADDITIVES FROM | | | |
| LISTING A: | | | |
| 11. Texanol | 2-5 | Coalescent | Eastman |
| 13. Gylcol Ether | 2-5 | Deflocculant | Univar |
| 15. Ware or solvent | 2-15 | Diluent | N/A |
| 16. Tamol 731 | 2-5 | Dispersant | Roham Haas |
| 18. Tung Oil | 2-10 | Essential Oils | Pacific Coats |
| | | | Chemical |
| 19. BYK 420 | 2-5 | Flow & leveling | BYK Additives |
| | | agent/or flow | |
| | | modifiers | |
| 22. Interwet 33 | 2-5 | Humectants | Akcros |
| | | | Chemicals |
| 23. BYK 094 | 2-5 | Lubricants | BYK Additives |
| 25. Plastomoll | 2-5 | Plasticizers | BASF |
| 27. Acusol | 2-5 | Rheology | Rohm Haas |
| | | modifier | |
| 28. Capstone | 2-5 | Spreading agent | DuPont |
| Fluorosurfactant | | | |
| 29. Surfynol 104 | 2-5 | Surfactant | Air Products |
| 31. Michelman 71235 | 1-5 | Wax additive | Michelman Inc. |

### Example 3

### Adhesive

Adhesives, in general, have many deleterious characteristics that heretofore have prevented adhesives from being successfully dispensed from a BOV aerosol dispensing arrangement. Among these adverse characteristics are:

1. A tendency to foam when atomized;

2. A tendency to corrode the metals in the dispensing valve and actuator of a dispensing arrangement;

3. A tendency to clog the valves and actuators of a dispensing arrangement;

4. A tendency to dry so rapidly that the dried adhesive will clog the valves and actuators;

5. A tendency to freeze at low temperatures;

6. A tendency to increase in pH over time which causes gelling and an inability to be atomized.

Table 5 below shows the formula for a typical liquid adhesive having some or all of the adverse characteristics 1-6 listed above and which, as a result, heretofore could not be successfully dispensed from a BOV aerosol dispensing arrangement

TABLE 5
LIQUID ADHESIVE

| | % by | | |
|---|---|---|---|
| Product | Volume | Description | Manufacturer |
| Elvace 40713 | 70-90 | vinyl acetate- | Forbo |
| | | ethylene | Bonding |
| | | copolymer | |
| | | emulsion | |
| Troysan 186 | .05-1 | Antimicrobial | Troy |
| Attagel | 1-3 | Clay | BASF |
| Surfynol | 2-5 | Surfactant | Air Products |
| Propylene Glycol | 2-5 | Solvent | Univar |
| TEA | .05-1 | Triethanolamine | Univar |

In order to change the characteristics of the adhesive of Table 5, one or more of the additives from Listing A are added to the adhesive to make the adhesive compatible with dispensing from a BOV aerosol dispensing arrangement. Table 6 shows the formulation of the adhesive of Table 5 with the selected additives of Listing A wherein one or more of the additives added to the liquid adhesive of Table 4 provides a liquid adhesive mixture that allows the liquid adhesive mixture to be dispensed from a BOV aerosol dispensing arrangement.

TABLE 6
BOV DISPENSABLE LIQUID ADHESIVE MIXTURE

| | % by | | |
|---|---|---|---|
| Product | Volume | Description | Manufacturer |
| Elvace 40713 | 70-90 | vinyl acetate- | Forbo |
| | | ethylene | Bonding |
| | | copolymer | |
| | | emulsion | |
| Troysan 186 | .05-1 | Antimicrobial | Troy |
| Attagel | 1-3 | Clay | BASF |
| Surfynol | 2-5 | Surfactant | Air Products |
| Propylene Glycol | 2-5 | Solvent | Univar |
| TEA | .05-1 | Triethanolamine | Univar |
| ADDITIVE FROM | | | |
| LISTING A | | | |
| 6. BYK-035 | 0.05-1 | Defoamer | BYK Additives |
| 12. Raybo 60 | .02-1 | Corrosion | Raybo |
| | | Inhibitor | |
| 14. Surfynol | 2-5 | Detergent | Air Products |
| 20. Propylene Glycol | 2-5 | Freez-Thaw | Univar |
| | | Stabilizer | |
| 24. Morpholine | 2-5 | pH Control | Huntsman |
| | | Stabilzer | |
| 26. Interwet 33 | 2-5 | Retention Aid | Akcros |
| | | | Chemicals |

From the above it can be seen that there has been presented teachings that will enable those skilled in the art to provide mixtures of many products which may be dispensed from a BOV aerosol dispensing arrangement and which products, absent the teachings herein cannot be successfully dispensed from a BOV aerosol dispensing arrangement.

While particular embodiments and applications of the present invention have been above described and illustrated, the present invention is not limited to the precise construction, formulae and arrangements disclosed. Those persons knowledgeable in the art may conceive of certain modifications, changes and variations in the detailed embodiments disclosed above as illustrative, to suit particular circumstances or products to be formed. The invention is therefore not intended to be limited to the preferred embodiments depicted, but only by the scope of the appended claims and embodiments reasonably equivalent thereto.

I claim:

1. A colored concrete coating composition comprising, in combination:
a colored concrete coating;
at least one additive added to said colored concrete coating, said additive selected from the class consisting of, in percentage by volume, inorganic filler such as calcium carbonate 5-15%, fumed silica such as silica nancomposites 1-3%, absorbent clay 1-3%, coupling agent such as tin catalyst 0.5-1%, anti-settling agent such as cellulose thickener 2-5%, emulsifier 2-5%, homogenizer 2-5% and suspension agent 2-5%, whereby said mixture of said colored concrete coating and said at least one additive provides a BOV aerosol dispensable colored concrete coating mixture.

2. The arrangement defined in claim 1 wherein:
said colored concrete coating comprised of, in percentage by volume: water 60-80%, defoamer 0.05-1%, acrylic resin 15-30%, antimicrobial 0.05-1%, wax additive 1-5%, pigment 1-5%.

3. The arrangement defined in claim 1 wherein:
more than one of said additives added to said colored concrete coating whereby said mixture of said colored concrete coating and said more than one additive provides a BOV aerosol dispensable colored concrete coating mixture. [symbol] more than one of said additives added to said colored concrete coating whereby said mixture of said colored concrete coating and said more than one additive provides a BOV aerosol dispensable colored concrete coating mixture.

5: A paint coating composition comprising, in combination:
a paint coating;
at least one additive added to said paint coating, said additive selected from the class consisting of, by volume: anti gelling agent 5-15%, anti livering agent 5-15%, coalescent 2-5%, deflocculant 2-5%, diluent, 2-15%, dispersant 2-5%, essential oils 2-10%, flow and leveling agent/flow modifiers 2-5%, humectants 2-5%, lubricants 2-5%, plasticizers 2-5%, rheology modifier 2-5%, spreading agent 2-5%, surfactant 2-5%, and was additive 1-5%, whereby said mixture of said paint coating and said at least one additive provides a BOV aerosol dispensable paint coating mixture.

6. The arrangement defined in claim 5 wherein:
said paint coating comprises in percentage by weight, acrylic resin 70-90%, defoamer 0.05-1% and liquid pigment 1-5%.

7. The arrangement defined in claim 5 wherein:
more than one of said additives added to said paint coating whereby said mixture of said paint coating and said more than one additive provides a BOV aerosol dispensable paint coating mixture.

8. The arrangement defined in claim 5 wherein:
more than one of said additives added to said paint coating whereby said mixture of said paint coating and said more than one additive provides a BOV aerosol dispensable paint coating mixture.

9. An adhesive composition comprising, in combination:
a liquid adhesive;
at least one additive added to said liquid adhesive, said at least one additive selected from the class consisting of, by volume: defoamer 0.05-1%, corrosion inhibitor 0.02-1%, detergent 2-5%, freeze-thaw stabilizer 2-5%, pH control stabilizer 2-5% and retention aid 2-5%, whereby said mixture of said liquid adhesive and said at least one additive provides a BOV aerosol dispensable liquid adhesive mixture.

10. The arrangement defined in claim 9 wherein:
said liquid adhesive comprises in percentage by weight, vinyl acetate-ethylene copolymer emulsion 70-90%, antimicrobial 0.05-1%, coalescent 2-5%, clay 1-3% and triethanolamine 0.05-1%.

11. The arrangement defined in claim 9 wherein:
more than one of said additives added to said liquid adhesive whereby said mixture of said liquid adhesive and said more than one additive provides a BOV aerosol dispensable liquid adhesive mixture.

12. The arrangement defined in claim 9 wherein:
more than one of said additives added to said liquid adhesive whereby said mixture of said liquid adhesive and said more than one additive provides a BOV aerosol dispensable liquid adhesive mixture.
